(19) United States
(12) Patent Application Publication
(10) Pub. No.: US 2004/0093337 A1
(43) Pub. Date: May 13, 2004

(54) Unified rights management for ipmp system

(76) Inventors: Sheng Mei Shen, Singapore (SG); Mi Ji, Singapore (SG); Zhongyang Huang, Singapore (SG); Takanori Senoh, Singapore (SG)

Correspondence Address: GREENBLUM & BERNSTEIN, P.L.C., 1950 ROLAND CLARKE PLACE, RESTON, VA, 20191, US

(21) Appl. No.: 10/471,281

(22) PCT Filed: Aug. 9, 2002
(86) PCT No.: PCT/JP02/08169

(30) Foreign Application Priority Data
Aug. 9, 2001 (JP) 2001-242402

(51) Int. Cl. G06F 7/00

(52) U.S. Cl. 707/100

(57) ABSTRACT

A method for any IPMP terminals or digital consumption terminal like MPEG-4 system achieves interoperability for handling rights management in different content distribution chains.

By using a defined and standardised unified rights description language and schema architecture world-wide, by defining the right place or position to hold such standardised rights schema in a content stream, by pre-implementing rights parser and rights management in a terminal based on such rights schema and the specified position for holding the rights descriptions, interoperability can be achieved across content distribution chain, across different countries, across different manufactures for making the terminal, and across different content providers. Such interoperability will bring us low cost for making the terminal, and also low cost to create and distribute a content.

Flexibility and extensibility are also provided since it is based on flexible and extensible XML-like language.

### TECHNICAL FIELD

The present invention relates to rights description and rights management in the content distribution chain, especially to such applications where content is rapped or encoded using MPEG system, such as MPEG-2, MPEG-4.

### BACKGROUND ART

As broadband network reaches to every home, content distribution is becoming more and more demanding. User is happy with the convenience, and they can enjoy entertainment more easily and efficiently than before.

In a content distribution chain, there are many parties involved in the operation of one content, from content owner, content distributor, to end-user.

First of all, content owner creates contents and post production house helps them to encode into certain formats like MPEG-2 or MPEG-4. In order to identify, protect and recognise each content, content owner will create usage rules to describe rights for different pieces of content.

When content is requested or distributed to user, different usage rules will be applied to different cases based on different business model or strategy. Such usage rules or rights description will be much different from one content distributor to another even for the same content owner.

Even content is encoded in the same format, like MPEG-2, but it still cannot achieve interoperability due to the different rights description or different usage rules.

The FIG. 1 shows the prior art for the current business model of content distribution and protection.

In FIG. 1 three content distribution and protection chains are explained here. Different usage rules structure or rights description languages are used in these three distribution chains. Therefore different rights management tools are also employed in different terminal to match with their own rights description language.

In module 1.0, Content Owner A places their rights or usage rules using Rights Description Language A.

In module 1.1, Content Owner B places their rights or usage rules using Rights Description Language B.

In module 1.2, Content Owner C places their rights or usage rules using Rights Description Language C.

In module 1.3, Content Distributor A places other rights or usage rules using Rights Description Language A.

In module 1.4, Content Distributor B places other rights or usage rules using Rights Description Language B.

In module 1.5, Content Distributor C places other rights or usage rules using Rights Description Language C.

In module 1.6, Terminal A uses Rights Management Tool A to interpret and process the rights and usage rules which are rapped by Content Owner A and Content distributor A.

In module 1.7, Terminal B uses Rights Management Tool B to interpret and process the rights and usage rules which are rapped by Content Owner B and Content distributor B.

In module 1.8, Terminal C uses Rights Management Tool C to interpret and process the rights and usage rules which are rapped by Content Owner C and Content distributor C.

This is very bad practise to terminal makers, because they have to implement different sets of rights management tools to handle different sets of rights description. It can be predicted that the cost of such terminal would be very high due to duplicate efforts put to implement different sets of rights management tools in the terminal.

So it is demanded that the same language has to define and use to describe rights in different content distribution chains to have interoperability and to reduce the cost for making terminal.

The descriptions of rights or usage rules have been talked and discussed in different places and organizations. Most of them are very general and cannot be used in MPEG related content distribution system, like MPEG-4 IPMP, MPEG-2 IPMP system.

On the other hand, there is no unified tool to be used in both content owner side and content distribution side to address their different rights related to different AV streams in MPEG-n IPMP system. At the same time the same mechanism is used in managing to apply such rights to different AV objects which are to be played back in different IPMP terminals.

To define a unified Rights Description Language in a flexible form to be used in all the content distribution and protection systems, especially in MPEG-n IPMP system, to provide horizontal interoperability;

To extract sub-set of the Rights Description as a profile to suite to MPEG-2 IPMP, MPEG-4 IPMP, as well as MPEG-7 IPMP;

To design Rights Parser and Rights Management Module or tool based on the Rights Description Language to be placed in the right places of MPEH-n IPMP system;

By standardising the above Rights Description Language, by extracting sub-sets of them for different applications as profiles, and by specifying the right place to put the Rights Management Tool in MPEG-n IPMP system, a flexible and interoperable DRM (Digital Rights Management) system for MPEG based content distribution and protection would be created world wide.

By having such standardised DRM system, the cost of such DRM terminal would be much less than that used in the existing business model which is based on close chain content distribution.

### DISCLOSURE OF INVENTION

First of all, a unified Rights Description Language with specified and clear semantics has to be defined and standardised in a flexible way.

A set of items/elements is extracted from the Rights Description Language to map to different applications, especially MPEG-n IPMP system.

A Rights Parser and Rights Management Tool has to be designed based on the Rights Description Architecture for such IPMP terminal.

A specified place has to be defined to hold such Rights Description in a content stream, especially in a MPEG-n IPMP stream.

Such a Rights Parser and Rights Management Tool is built into an IPMP terminal in right place to process each right applied to different AV streams or objects.

An Authorising Tool is provided to both content production and content distribution, to allow different parties in a distribution chain to place their different rights easily, which can be done in off line, or in real time.

On the content production side, a media content is encoded using existing coding technology like MPEG-2 or MPEG-4, and encrypted using existing IPMP tools like DES or AES.

A unified Rights Description Language is defined to reflect different types of rights or usage rules in the content distribution chain, especially in MPEG related content distribution world.

Besides we need to define and standardize the structure/schema/architecture, we also need to clearly define the semantics of each element, as well as the relationship between different elements.

An authoring tool is built based on the standardised Rights Description Language to use in content production to:

1) Embed watermark information like copyright, content ID, Authors, etc before the encoding;

2) Place the rights or usage rules for the content;

3) Construct XML-like notations based on the requirements of the content owner;

The same authoring tool is used in content distribution to:

4) Place different rights, usage rules, license condition, etc using the tool, and some are done off the line and some are done in real-time at the point when user subscribes and makes their payments;

5) Construct XML-like notations based on such rights;

6) Combine all these XML-like notations into one file as an envelope for the content;

7) Convert such file into binary format;

8) Insert such file in binary format into the content stream in the specified position which is fixed and standardized in different MPEG-n IPMP system, before transmitting to MPEG-n IPMP terminal;

On a Terminal Side:

The same Rights Description Language based on the specified structure, schema, or architecture for describing the rights is used to design a Rights Management Tool for MPEG-n IPMP terminal. Such Rights Management Tool consists of the Rights Parser built based on the same structure, schema, or architecture, as well as the Rights Manager built based on the semantics defined in the Rights Description language. By having such Rights Management Tool in a MPEG-n IPMP terminal, the rights expressed in a XML-like file which is carried in the content stream, would be interpreted and transferred to different parts of the terminal to excise their rules. The detail process will be:

9) Receive the content stream with XML-like file in binary format in a MPEG-n IPMP terminal;

10) Convert the XML-like file from binary format into XML-like readable format;

11) Interpret each of the elements in the XML-like file by the Rights Parser in the terminal;

12) Transfer and apply each of the rights or rules to the corresponding parts of the terminal to excise the rights management by the Rights Manager;

Finally, all the MPEG-n IPMP terminal built with such Standardized Rights Management Tool will be able to operate everywhere without re-implementing different set of Rights Management Tools in different countries or for handling contents provided by different content agents. A lot of resource will be saved and therefore the cost of such terminal devices would be kept much lower.

This invention solves the problem for terminals to implement different Rights Descriptions to play back digital content from different content distribution chains. It provides the interoperability for the same terminal to be used in different countries, in different content distribution chains as long as they are built based on the same standard for presentation layer like MPEG-2, or MPEG-4.

Besides interoperability it also provides better flexibility and extensibility to allow different kinds of usage rules or rights to place for different content providers since it is based on extensible and flexible language, like XML.

At the same time, a unified Authoring Tool built based on standardised Rights Description Schema Architecture provides a tidy and clean Rights Scene Structure to content creator and distributor.

A compliant IPMP Terminal built with a Rights Parser and Rights Management based on the standardised Rights Description Schema will be interoperable and also less expensive since it is built once and used for everywhere no matter who are the content providers.

### BRIEF DESCRIPTION OF DRAWINGS

FIG. 1 shows the prior art for different Rights Description Language and Rights Management used different distribution chain.

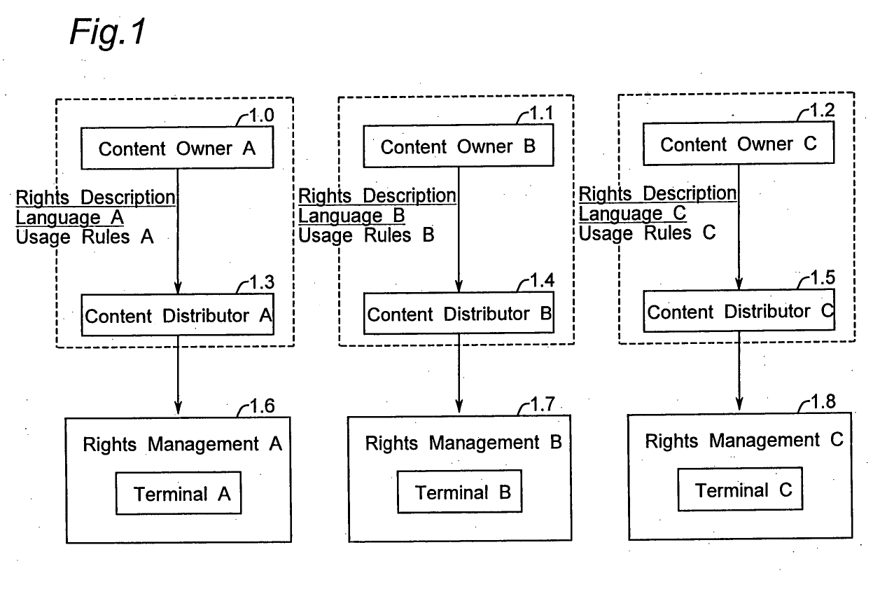

FIG. 2 shows the General Structure for Rights Handling on both sides of content creation and consumption in MPEG-n IPMP System.

FIG. 3 shows the General Structure for Rights Handling on both sides of content creation and consumption in MPEG-4 IPMP System.

FIG. 4 shows the General Structure for Rights Handling on both sides of content creation and consumption in MPEG-2 IPMP System.

FIG. 5 shows the General Structure for Rights Handling on both sides of content creation and consumption in MPEG-7 IPMP System.

FIG. 6 shows the General Structure for Rights Handling on both sides of content creation and consumption in non-MPEG IPMP System.

FIG. 7 shows Rights Description Language and Schema for MPEG-n IPMP System.

FIG. 8 shows Rights Description Language and Schema for MPEG-n IPMP System.

FIG. 9 shows Content Stream Structure with IOD and Rights Description Scene in a MPEG-4 IPMP System.

FIG. 10 shows Rights Description carried by IMPM_ES in a MPEG-4 IPMP System.

FIG. 11 shows MPEG-2 System Stream Structure with Private Section to Carry Rights Descriptions for Different Elementary Streams using Elementary_PID.

FIG. 12 shows MPEG-2 System Stream Structure with special PES as private_stream to Carry Rights Descriptions for Different Elementary Streams Using Elementary_PID.

### BEST MODE FOR CARRYING OUT THE INVENTION

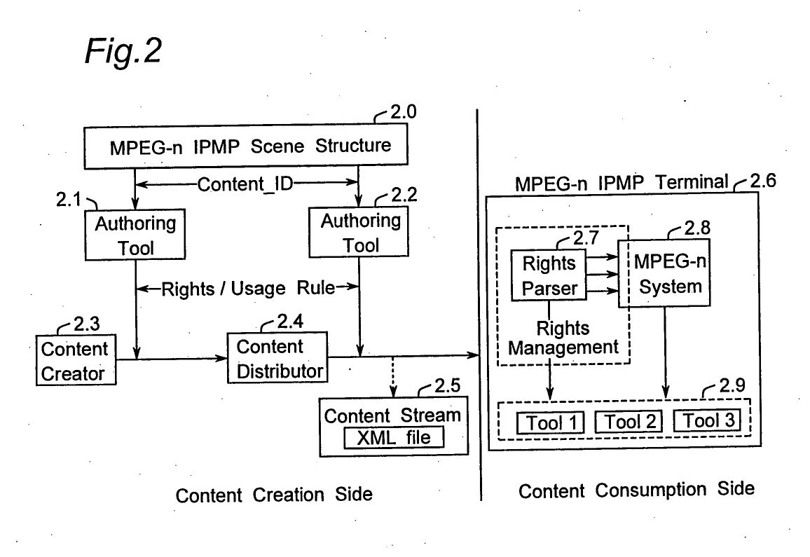

FIG. 2 shows the generic structure for rights handling on both content distribution side and content consumption side in MPEG-n IPMP system.

On the Content Creation and Distribution Side:

At first, MPEG-n IPMP Scene Structure in module 2.0 will be constructed as an input file to the Authoring Tool in module 2.1 and 2.2. The Authoring Tool in module 2.1 and 2.2 are the same tool and built based on the standardized Rights Description Language. ObjectID or Object Sub-ID is used for identifying different digital content items, and will be put together with Usage Rules/rights to identify which object the rights are applied to.

In module 2.3 Content Creator creates and encodes contents into certain format, and at the same time, Rights and Usage Rules are inserted and attached to the content as the envelope by using the Authoring Tool in module 2.1.

In module 2.4 Content Distributor determines the detail Rights and Usage Rules, raps the contents, and adds in more usage rules to the envelop by using the same Authoring Tool in module 2.2. It is also possible to automatically add in different rights and usage rules to the envelope at the point of time when user (terminal) makes different request or payment.

Finally the rights and usage rules for that piece of content will be represented in XML and converted to binary to attach to the Content Stream, in module 2.5, to be ready to deliver to terminal.

On the Content Consumption Side:

In module 2.6 it is shown that a compliant MPEG-n IPMP Terminal will be able to interpret the XML based rights and usage rules in module 2.7 for Rights Parser function.

Based on the clear semantics, the terminal is able to transfer such rights and usage rules to each corresponding control parts in the terminal, and such information will be used in MPEG-n System in module 2.8 and control different IPMP Tools in module 2.9.

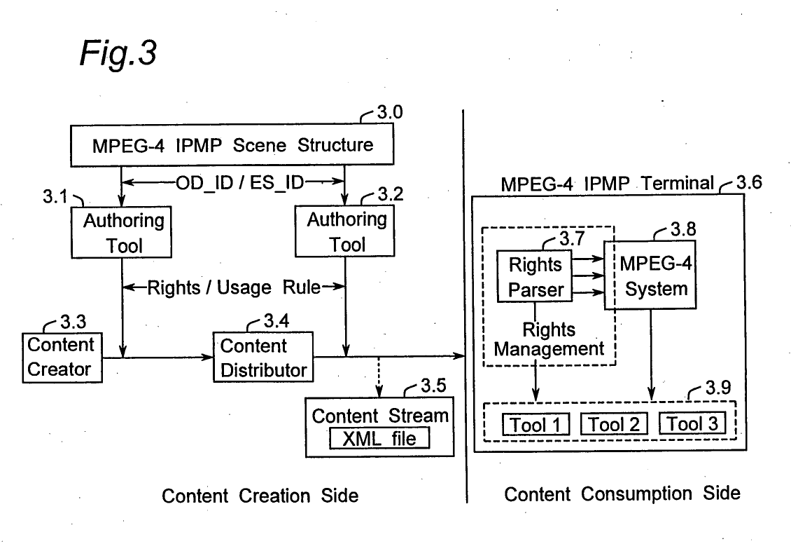

FIG. 3 shows the generic structure for rights handling on both content distribution side and content consumption side in MPEG-4 IPMP system.

On the Content Creation and Distribution Side:

At first, MPEG-4 IPMP Scene Structure in module 3.0 will be constructed as an input file to the Authoring Tool in module 3.1 and 3.2. The Authoring Tool in module 3.1 and 3.2 are the same tool and built based on the standardized Rights Description Language. OD_ID or/and ES-ID is used for identifying different digital objects, and will be put together with Usage Rules/rights to identify which object the rights are applied to.

In module 3.3 Content Creator creates and encodes contents into certain format, and at the same time, Rights and Usage Rules are inserted and attached to the content as the envelope by using the Authoring Tool in module 3.1.

In module 3.4 Content Distributor determines the details of Rights and Usage Rules, raps the contents, and adds in more usage rules to the envelop by using the same Authoring Tool in module 3.2. It is also possible to automatically add in different rights and usage rules to the envelope at the point of time when user (terminal) makes different request or payment.

Finally the rights and usage rules for that piece of content will be represented in XML-like language and converted into binary to attach to the Content Stream in module 3.5, to be ready to deliver to terminal.

On the Content Consumption Side:

In module 3.6 it is shown that a compliant MPEG-4 IPMP Terminal will be able to interpret the XML based rights and usage rules in module 3.7 for Rights Parser function.

Based on the clear semantics, the terminal is able to transfer such rights and usage rules to each corresponding control parts in the terminal, and such information will be used in MPEG-4 System in module 3.8 and control different IPMP Tools in module 3.9.

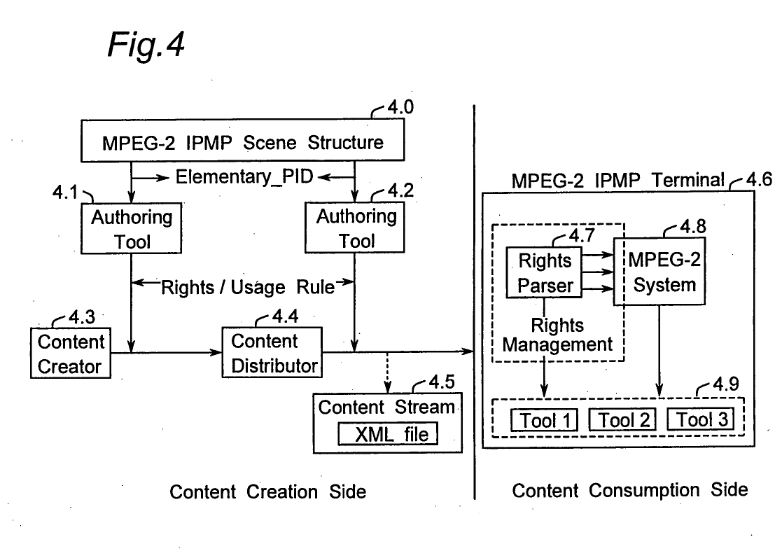

FIG. 4 shows the generic structure for rights handling on both content distribution side and content consumption side in MPEG-2 IPMP system.

On the Content Creation and Distribution Side:

At first, MPEG-2 IPMP Scene Structure in module 4.0 will be constructed as an input file to the Authoring Tool in module 4.1 and 4.2. The Authoring Tool in module 4.1 and 4.2 are the same tool and built based on the standardized Rights Description Language. Elementary_PID in MPEG-2 System is used for identifying different digital content items such as video1, video 2, audio1, or audio2, and Elementary_PIDs will be put together with Usage Rules/rights to identify which digital object/item the rights are applied to.

In module 4.3 Content Creator creates and encodes contents into certain format, and at the same time, Rights and Usage Rules are inserted and attached to the content as the envelope by using the Authoring Tool in module 4.1.

In module 4.4 Content Distributor determines the detail Rights and Usage Rules, raps the contents, and adds in more usage rules to the envelop by using the same Authoring Tool in module 4.2. It is also possible to automatically add in different rights and usage rules to the envelope at the point of time when user (terminal) makes different request or payment.

Finally the rights and usage rules for that piece of content will be represented in XML and converted to binary to attach to the Content Stream in module 4.5, to be ready to deliver to terminal.

On the Content Consumption Side:

In module 4.6 it is shown that a compliant MPEG-2 IPMP Terminal will be able to interpret the XML based rights and usage rules in module 4.7 for Rights Parser function.

Based on the clear semantics, the terminal is able to transfer such rights and usage rules to each of the corresponding control parts in the terminal, and such information will be used in MPEG-2 System in module 4.8 and control different IPMP Tools in module 4.9.

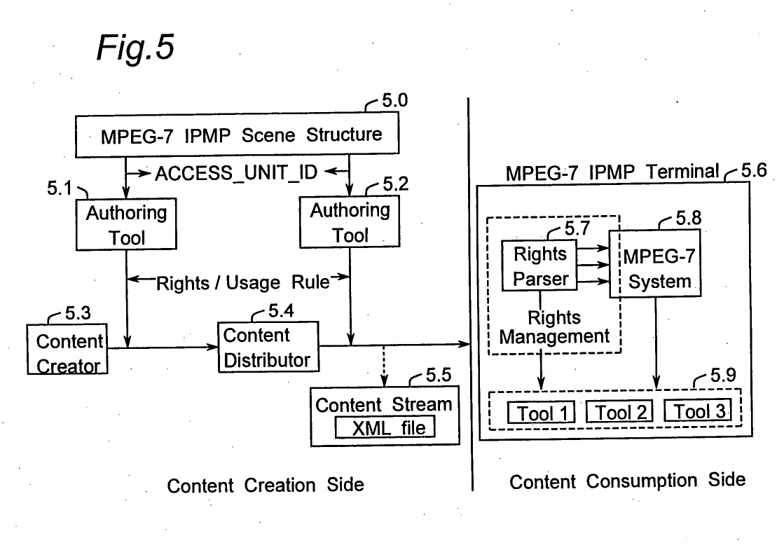

The same concept and method is also applicable to the content distribution for MPEG-7 digital item as shown in FIG. 5.

On the Content Creation and Distribution Side:

At first, MPEG-7 IPMP Scene Structure in module 5.0 will be constructed as an input file to the Authoring Tool in module 5.1 and 5.2. The Authoring Tool in module 5.1 and 5.2 are the same tool and built based on the standardized Rights Description Language. Access_Unit_ID is used for identifying different digital content items, and Access_Unit_IDs will be put together with Usage Rules/rights to identify which digital object/item the rights are applied to.

In module 5.3 Content Creator creates and encodes contents into certain format, and at the same time, Rights and Usage Rules are inserted and attached to the content as the envelope by using the Authoring Tool in module 5.1.

In module 5.4 Content Distributor determines the detail Rights and Usage Rules, raps the contents, and adds in more usage rules to the envelop by using the same Authoring Tool in module 5.2. It is also possible to automatically add in different rights and usage rules to the envelope at the point of time when user (terminal) makes different request or payment.

Finally the rights and usage rules for that piece of content will be represented in XML and converted to binary to attach to the Content Stream in module 5.5, to be ready to deliver to terminal.

On the Content Consumption Side:

In module 5.6 it is shown that a compliant MPEG-7 IPMP Terminal will be able to interpret the XML based rights and usage rules in module 5.7 for Rights Parser function.

Based on the clear semantics, the terminal is able to transfer such rights and usage rules to each of the corresponding control parts in the terminal, and such information will be used in Playback System in module 5.8 and control different IPMP Tools in module 5.9.

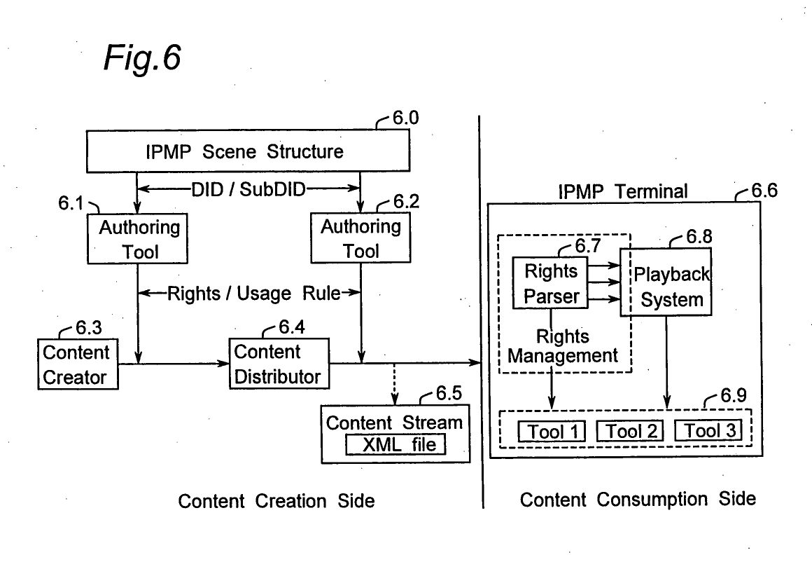

The same concept and method is also applicable to the content distribution for generic digital item as shown in FIG. 6.

On the Content Creation and Distribution Side:

At first, IPMP Scene Structure in module 6.0 will be constructed as an input file to the Authoring Tool in module 6.1 and 6.2. The Authoring Tool in module 6.1 and 6.2 are the same tool and built based on the standardized Rights Description Language. DID (Digital Item Identifier) is used for identifying different digital content items, and DIDs will be put together with Usage Rules/rights to identify which digital object/item the rights are applied to.

In module 6.3 Content Creator creates and encodes contents into certain format, and at the same time, Rights and Usage Rules are inserted and attached to the content as the envelope by using the Authoring Tool in module 6.1.

In module 6.4 Content Distributor determines the detail Rights and Usage Rules, raps the contents, and adds in more usage rules to the envelop by using the same Authoring Tool in module 6.2. It is also possible to automatically add in different rights and usage rules to the envelope at the point of time when user (terminal) makes different request or payment.

Finally the rights and usage rules for that piece of content will be represented in XML and converted to binary to attach to the Content Stream in module 6.5, to be ready to deliver to terminal.

On the Content Consumption Side:

In module 6.6 it is shown that a compliant IPMP Terminal will be able to interpret the XML based rights and usage rules in module 6.7 for Rights Parser function. Based on the clear semantics, the terminal is able to transfer such rights and usage rules to each of the corresponding control parts in the terminal, and such information will be used in Playback System in module 6.8 and control different IPMP Tools in module 6.9.

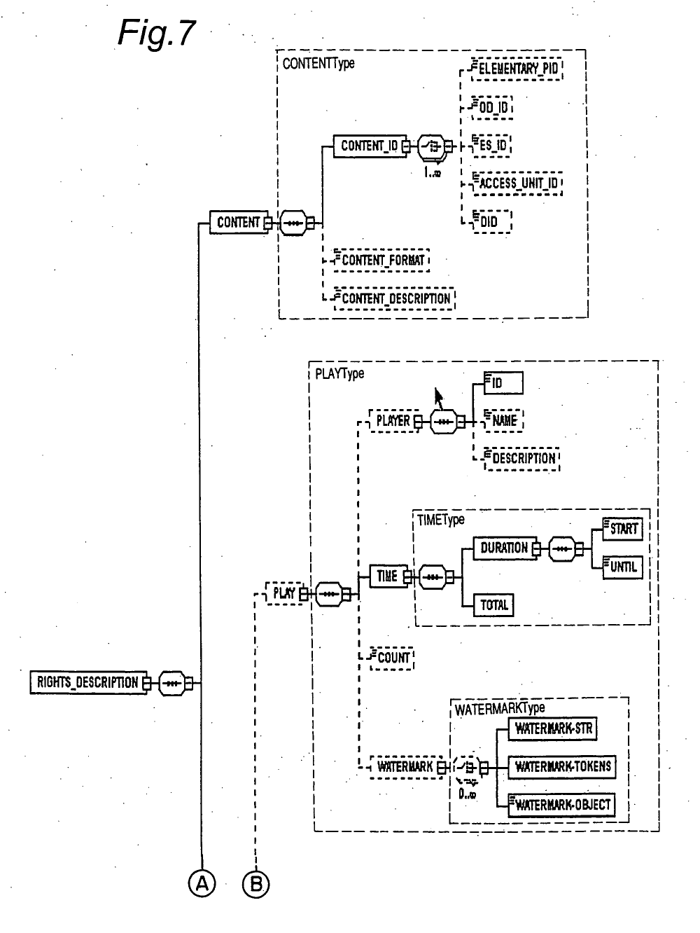

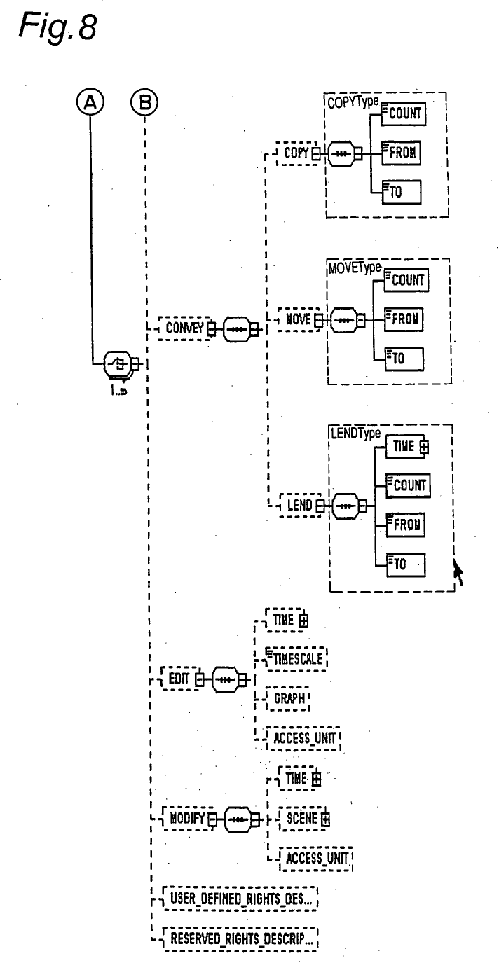

In FIG. 7 and FIG. 8, a defined Rights Description Language or Schema Architecture is presented to cover as many usage rules and rights as possible in different applications. All the elements or attributes in parent notes, children notes are clearly specified in the section of The Semantics of Rights Description Language. Content_ID in the schema will be changed into Elementary_PID when we describe digital item in MPEG-2 system, and OD-ID/ES_ID when we describe digital item in MPEG-4 system, and Access_Unit_ID when we describe digital item in MPEG-7 system.

The Semantics of Rights Description Language

The semantics of Rights Description Language are as follows:

1) CONTENT: This element is a generic entity for identifying some content information. It consists of one mandatory element CONTENT_ID and two optional elements CONTENT_FORMAT and CONTENT_DESCRIPTION.

For different IPMP system, different CONTENT_ID can be chosen with its corresponding rights and usage rules to apply. ELEMENTARY_PID in a PMT table for MPEG-2 system, ES_ID and/or OD_ID for MPEG-4 system, ACCESS_UNIT_ID for MPEG-7 system, and DID for common digital content. CONTENT_FORMAT provides encoding content format like MPEG-2, 4 or 7 and CONTENT_DESCRIPTION gives content description such as AudioVisual stream, AudiaVisual object, AudioVisual descriptions matadata, etc.

The following elements explains the possible rights and usage rules semantics for Rights Descriptions:

2) PLAY: play rights can be understood as playing requires active participation by a trusted player to render the content during the time allowed and with limited times.

“COUNT” provides a number of times, which allows the content to be played back. Every time the content is played back, the value is decreased by one. When the value becomes to zero, the content cannot be played any more.

“PLAYER” can optionally be specified as the kind of hardware for playing. “ID”, “NAME”, and “DESCRIPTION” give the detail of player properties.

“TIME” provides the time attribute of content playing. “DURATION” provides a time period which allows the content to be played. From the time “START” until the time “UNTIL”, the content can be played. Before the “DURATION” and after the “DURATION”, the content cannot be played.

“TOTAL” time provides a total amount of time which allows the content to be played. When the content is played, the value of “TOTAL”(Year, Month, Day, Hour, Minute, Second) is decreased at a certain time interval. When the time elapses, the content cannot be played. The total amount of time that “TOTAL” element provides cannot be more than the time amount provided by “START” and “UNTIL” but can be equal to or less than it.

When “WATERMARK” is used, then a watermark specifies a list of sources of information which a content provider requests what information should be expressed in the watermark. The elements of the list can be strings of text known at the time the content is provided (Watermark-Str), they can be lists of tokens signifying “fingerprint” information known at the time the content is played back (Watermark-Token), or they can be digital objects whose bits are to be encoded (Watermark-Object). The objects are assumed to be sent in the contents being played.

3) COPY, MOVE, LEND: these three rights can be understood as particular types of CONVEY right which govern the creation and movement of persistent copies of content under the control of trusted provider.

These three types of rights all can be parameterized by “COUNT” which specifies the number of copies, moves, and loans, and “FROM”, “TO” which specify the memories (repositories) to exchange the content. Each time the content is copied, moved, or loaned, the value of “COUNT” is decreased. When the number becomes to zero, the content cannot be copied, moved, or lent any more.

A COPY right is the right to make a new digital copy of the content and it is invoked whenever a new digital copy is made.

A MOVE right is the right to transfer the digital content from one memory (repository) to another and it does not increase the number of copies of a content.

A LEND right is the right to loan a copy of the content for a period of time and it also creates a “lender” copy of the content on another memory (repository). It is not the same as “COPY” and “MOVE” right, because, typically, during the time that the content is lent, the original copy of the content cannot be played.

The “LEND” right has a special attribute “TIME” which is same as the “TIME” in “PLAY” to denote the time factor when “lending” memory is activated and original “lent” memory deactivates.

4) EDIT right grants the right to edit the graphs or control the time when playing the contents or metadata relationship. For example, changing the time scale can provide the functionalities of fast forward and backward, slow action, pause, etc; adjusting MPEG-7 metadata Access_Unit relations (tree structures) can provide different search utilities.

5) MODIFY right gives the permissions to change the content, replace the content with other or create a new content. Two examples of “MODIFY” right in MPEG IPMP are replacing the current scene with the specified scene by the user in MPEG-4 system and modifying Access_Unit element value to adjust search functionality in MPEG-7 system.

In above two rights notion, “TIME” element has the same explanation as the “TIME” in “PLAY” and “LEND” rights to denote the effective time factor when activating these two rights.

6) UserDefinedRightsDescription: it provides any rights descriptions defined by users. The semantics is defined by the users.

7) ReservedRightsDescription: it provides the rights descriptions for future use.

These Rights Descriptions are managed by the Rights Management tool, in order to control the content consumption according to the content provider's intention.

As shown in FIGS. 2, 3, 4, 5, and 6, Rights Management Tool with Rights Parser has to be pre-implemented in the terminal based on the standardized Rights Description Schema Architecture which is also used in the content creation side. This is the same situation as Audio and video codec, encoder and decoder should a pair.

The following section shows the XML notation as examples of rights and usage rules for certain application by using the standardized Rights Description Schema Architecture.

Examples for XML Notation of Rights and Usage Rules for MPEG-4 IPMP System

The following XML notation describes the syntax of Rights Description in the MPEG-2 IPMP information. PLAY and COPY rights are authorized to a specified AudioVisual Stream Video part with the specified Elementary_PID.

<?xml version=“1.0” encoding=“UTF-8”?>

| | |
|---|---|
| <RIGHTS_DESCRIPTION | xmlns:xsi=“http://www.w3.org/2001/XMLSchema- |

| | |
|---|---|
| instance” | xmlns:xsi=“http://www.mpeg_ipmp.org/2001/MPEG-IPMP- |
| Schema”> | |

<CONTENT>

<CONTENT_ID>

<ELEMENTARY_PID> EPID5 </ELEMENTARY_PID>

| </CONTENT_ID> | | | |
|---|---|---|---|
| <CONTENT_FORMAT> MPEG-2 </CONTENT_FORMAT> | | | |
| <CONTENT_DESCRIPTION> | Audiovisual | Stream | Video5 |

<CONTENT_DESCRIPTION>

</CONTENT>
<PLAY>

<PLAYER>

<ID>Panasonic8910</ID>

<NAME>CF-X1</NAME>
<DESCRIPTION>Notebook Player</DESCRIPTION>

</PLAYER>
<TIME>

<DURATION>

<START>2001-07-20</START>
<UNTIL>2001-07-22</UNTIL>
</DURATION>
<TOTAL days=“2” hours=“5”/>

</TIME>
<WATERMARK>

<WATERMARK-STR string=“Title:‘Songs’ Copyright 2001
Panasonic”/>
<WATERMARK-TOKENS user-id=“true” render-id=“true”/>

</WATERMARK>

</PLAY>
<CONVEY>

<COPY>
<COUNT>1</COUNT>

<FROM>AAA</FROM>
<TO>BBB</TO>

</COPY>

</CONVEY>

</RIGHTS_DESCRIPTION>

The following XML notation describes the syntax of Rights Description in the MPEG-4 IPMP information. PLAY, MOVE, EDIT, MODIFY rights are authorized to some specified AudioVisual Objects with the specified ES_ID and OD_ID.

<?xml version=“1.0” encoding=“UTF-8”?>

| | |
|---|---|
| <RIGHTS_DESCRIPTION | xmlns:xsi=“http://www.w3.org/2001/XMLSchema- |

| | |
|---|---|
| instance” | xmlns:xsi=“http://www.mpeg_ipmp.org/2001/MPEG-IPMP- |
| Schema”> | |

<CONTENT>

<CONTENT_ID>

<OD_ID>8</OD_ID>
<OD_ID>9</ES_ID>
<ES_ID>9</ES_ID>

| </CONTENT_ID> | | | | |
|---|---|---|---|---|
| <CONTENT_FORMAT> MPEG-4 </CONTENT_FORMAt> | | | | |
| <CONTENT_DESCRIPTION> | AV | Objects | Video8 | Audio9 |

<CONTENT_DESCRIPTION>

</CONTENT>
<PLAY>

<PLAYER>

<ID>Panasonic9910</ID>
<NAME>CF-L1</NAME>
<DESCRIPTION>MD Player</DESCRIPTION>

</PLAYER>
<TIME>

<DURATION>

<START>2001-07-20</START>
<UNTIL>2001-10-22</UNTIL>

</DURATION>
<TOTAL days=“50” hours=“8”/>

</TIME>
<COUNT>10</COUNT>
<WATERMARK>

<WATERMARK-STR string=“Title:‘MD Songs’ Copyright 2001
Panasonic”/>
<WATERMARK-TOKENS user-id=“true” render-id=“false”/>

</WATERMARK>

</PLAY>
<CONVEY>

<MOVE>

<COUNT>2</COUNT>
<FROM>CCC</FROM>
<TO>DDD</TO>

</MOVE>

</CONVEY>
<EDIT>

<TIMESCALE>10000</TIMESCALE>
<TIMESCALE>10</TIMESCALE>
<TIMESCALE>0.1</TIMESCALE>

</EDIT>
<MODIFY>

<SCENE><FROM>Scene 1</FROM><TO>Scene 2</TO></SCENE>

</MODIFY>

</RIGHTS_DESCRIPTION>

The following XML notation describes the syntax of Rights Description in the MPEG-7 IPMP information. LEND, EDIT, MODIFY rights are authorized to a specified AudioVisual Description Metadata with the specified ACCESS_UNIT_ID.

<?xml version=“1.0” encoding=“UTF-8”?>

| | |
|---|---|
| <RIGHTS_DESCRIPTION | xmlns:xsi=“http://www.w3.org/2001/XMLSchema- |

| | |
|---|---|
| instance” | xmlns:xsi=“http://www.mpeg_ipmp.org/2001/MPEG-IPMP- |
| Schema”> | |

<CONTENT>

<CONTENT_ID>

<ACCESS_UNIT_ID>9</ACCESS_UNIT_ID>
<ACCESS_UNIT_ID>10</ACCESS_UNIT_ID>

| </CONTENT_ID> | | |
|---|---|---|
| <CONTENT_FORMAT> MPEG-7 </CONTENT_FORMAT> | | |
| <CONTENT_DESCRIPTION>Football | Game | AV |

Description<CONTENT_DESCRIPTION>

</CONTENT>
<CONVEY>

<LEND>

<TIME>

<DURATION>

<START>2001-07-13</START>
<UNTIL>2001-09-16</UNTIL>

</DURATION>
<TOTAL months=“1” days=“2”></TOTAL>

</TIME>
<COUNT>3</COUNT>
<FROM>EEE</FROM>
<TO>FFF</TO>

</LEND>

</CONVEY>
<EDIT>

<ACCESS_UNIT> AUID 9 left connection parent node with AUID 10

</ACCESS_UNIT>

</EDIT>
<MODIFY>

<ACCESS_UNIT>Element ‘ball’</ACCESS_UNIT>
<ACCESS_UNIT>Element ‘player’</ACCESS_UNIT>

</MODIFY>

</RIGHTS_DESCRIPTION>

In the terminal side, it can have optional BiM software that decodes the above XML description of the Rights Descriptions information in binary compressed form to XML file with the following defined schema which is used to parse the XML description. A XML Rights Parser gets the element values and/or attributes from XML file using the defined schema and transfer to the terminal control part to implement Rights Management.

The Position or Place to Carry Rights Descriptions in MPEG-4 IPMP System

MPEG-4 IPMP System:

On Content Creation Side, Rights/Usage Rules based on XML Schema are inserted into a content stream in the IOD of MPEG-4 content stream as MPEG-4 IPMP Scene Structure. This can be done in the help of Authoring Tool at the point of time when content is created and distributed.

On Content Consumption Side, Rights Parser interprets every notes of XML file and transfers them to the corresponding components in a MPEG-4 terminal according to OD_ID/ES_ID indicated in the XML file.

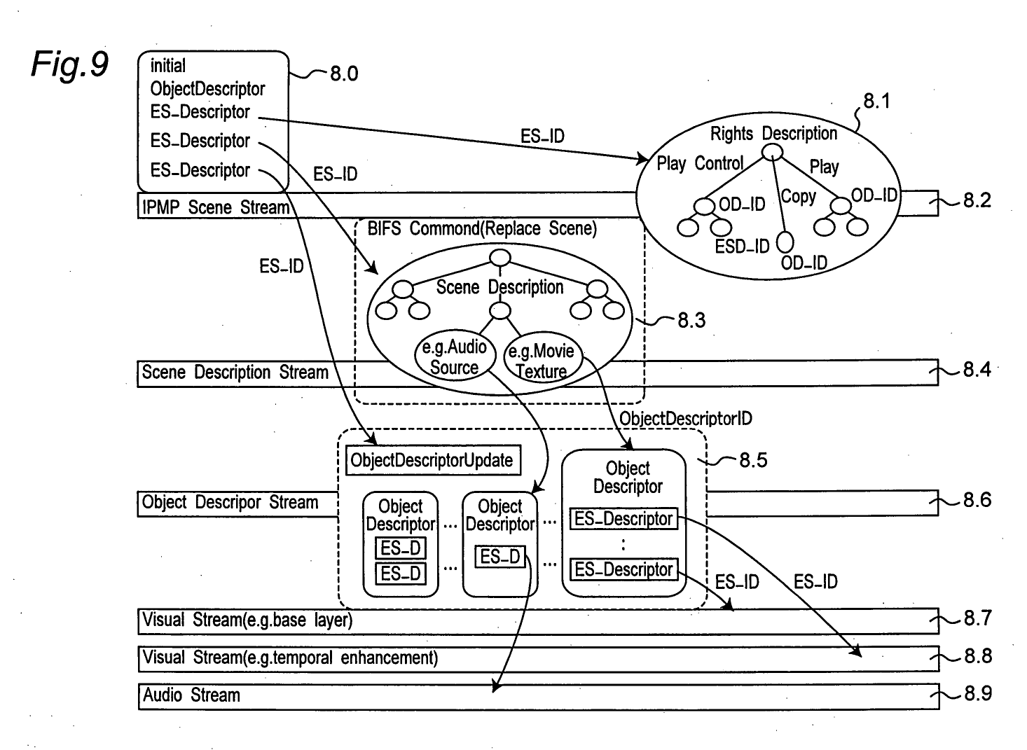

The XML based Rights Expression (in binary format) can be carried in one of the Elementary Streams like Scene Description Stream or Object Description Stream, as shown in FIG. 9. Inside the IOD (Initial Object Descriptor), an ES_Descriptor will describe the stream.

In FIG. 9, three ES_Descriptors are carried in the IOD in module 8.0. One is used for Object Descriptor Stream in module 8.6, one is used for Scene Descriptor Stream in module 8.4, and the other is used for IPMP Scene Stream in module 8.2.

Three elementary streams are shown in module 8.7. 8.8, and 8.9 for videos and audio. Object Descriptor in module 8.5 describes each of objects and each of the elementary streams.

BIFS (binary Format Scene) is shown in module 8.3 to illustrate the relationship between different objects indicated in module 8.5.

Rights Description in module 8.1 illustrates the different usage rules or rights applied to different objects indicated by OD-ID/ES_ID in the terminal.

This way is good if we consider compatibility with old IPMP system, and if we prefer a tidy and clear Rights Structure for all the Objects set up in the beginning of decoding. At the same time we also can provide an Overall IPMP Scene Structure to be used in the Content Creation to illustrate the relationship for different kinds of Rights applied to different objects.

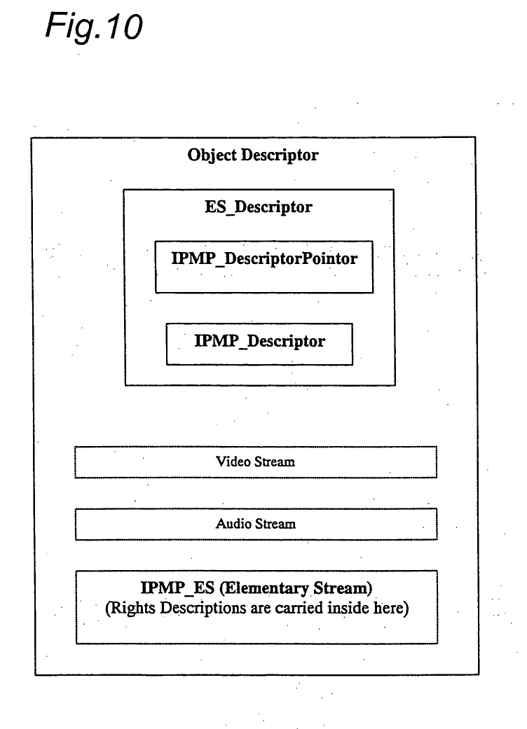

Alternative way is to put separate usage rules/rights in an IPMP Elementary stream to attach to the object and elementary stream which is the target for rights to apply to, as shown in FIG. 10.

The Position or Place to Carry Rights Descriptions in MPEG-2 IPMP System

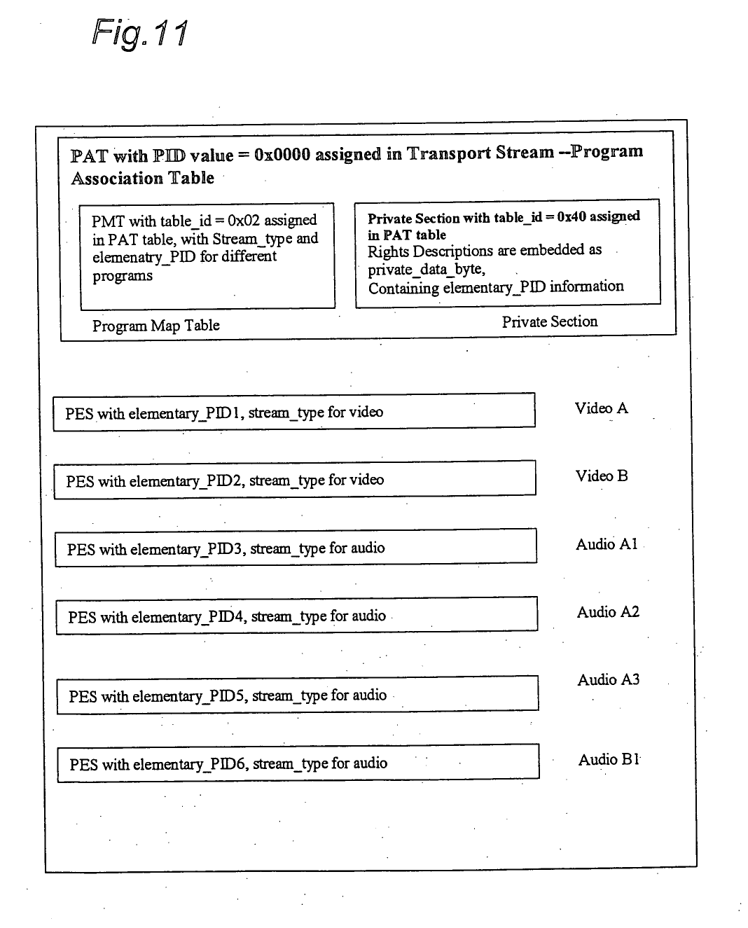

In FIG. 11, it is shown that Rights Description can be carried in a Private Section which is assigned in PAT (Program Association table) table in a MPEG-2 system.

In FIG. 11, a PAT table with PID value=1x0000 assigned by TS (Transport Stream) is illustrated.

A PMT (Program Map Table) table with table_id=0x02 assigned by the above PAT table is shown here. Inside the PMT table, all the programs with different stream_type and elementary_PID are listed to tell the relationship between each elementary stream, as shown in Table 1 for the syntax of PMT defined in MPEG-2 system.

TABLE 1
Transport Stream Program Map section

| | | |
|---|---|---|
| | No. of | |
| Syntax | bits | Mnemonic |

TS_program_map_section( ) {

| | | |
|---|---|---|
| table_id | 8 | uimsbf |
| section_syntax_indicator | 1 | bslbf |
| ‘0’ | 1 | bslbf |
| reserved | 2 | bslbf |
| section_length | 12 | uimsbf |
| program_number | 16 | uimsbf |
| reserved | 2 | bslbf |
| version_number | 5 | uimsbf |
| current_next_indicator | 1 | bslbf |
| section_number | 8 | uimsbf |
| last_section_number | 8 | uimsbf |
| reserved | 3 | bslbf |
| PCR_PID | 13 | uimsbf |
| reserved | 4 | bslbf |
| program_info_length | 12 | uimsbf |
| for (i=0; i<N; i++) { | | |

descriptor( )

}
for (i=0;i<N1;i++) {

| | | |
|---|---|---|
| stream_type | 8 | uimsbf |
| reserved | 3 | bslbf |
| elementary_PID | 13 | uimsnf |
| reserved | 4 | bslbf |
| ES_info_length | 12 | uimsbf |
| for (i=0; i<N2; i++) { | | |

descriptor( )

}

| } | | |
|---|---|---|
| CRC_32 | 32 | rpchof |

}

In FIG. 11, six PES streams are shown to illustrate the different elementary streams with different stream_type and different elementary_PID.

Rights Descriptions are embedded as private_data_byte and carried inside the Private Section with table_id=0x40 which is assigned in PAT table. Table 2 shows the syntax for Private Section defined in MPEG-2 system.

TABLE 2
Private Section

| | | No. of | |
|---|---|---|---|
| Syntax | | bits | Mnemonic |
| private_section( ) { | | | |
| | table_id | 8 | uimsbf |
| | section_syntax_indicator | 1 | bslbf |
| | private_indicator | 1 | bslbf |
| | reserved | 2 | bslbf |
| | private_section_length | 12 | uimsbf |
| | if (section_syntax_indicator = = ‘0’) { | | |

for ( I=0;i<N;i++) {

| | | |
|---|---|---|
| private data byte | 8 | bslbf |

}

}
else {

| | | |
|---|---|---|
| table_id_extension | 16 | uimsbf |
| reserved | 2 | bslbf |
| version_number | 5 | uimsbf |
| current_next_indicator | 1 | bslbf |
| section_number | 8 | uimsbf |
| last_section_number | 8 | uimsbf |
| for(i=0;i<private_section_length- | | |

| 9;i++) { | | | |
|---|---|---|---|
| | private_data_byte | 8 | bslbf |

| } | | |
|---|---|---|
| CRC_32 | 32 | rpchof |

}

}

Rights Descriptions are created on content creation and distribution side, and they consist of elementary_PID information to tell what rights apply to which object item or which elementary stream.

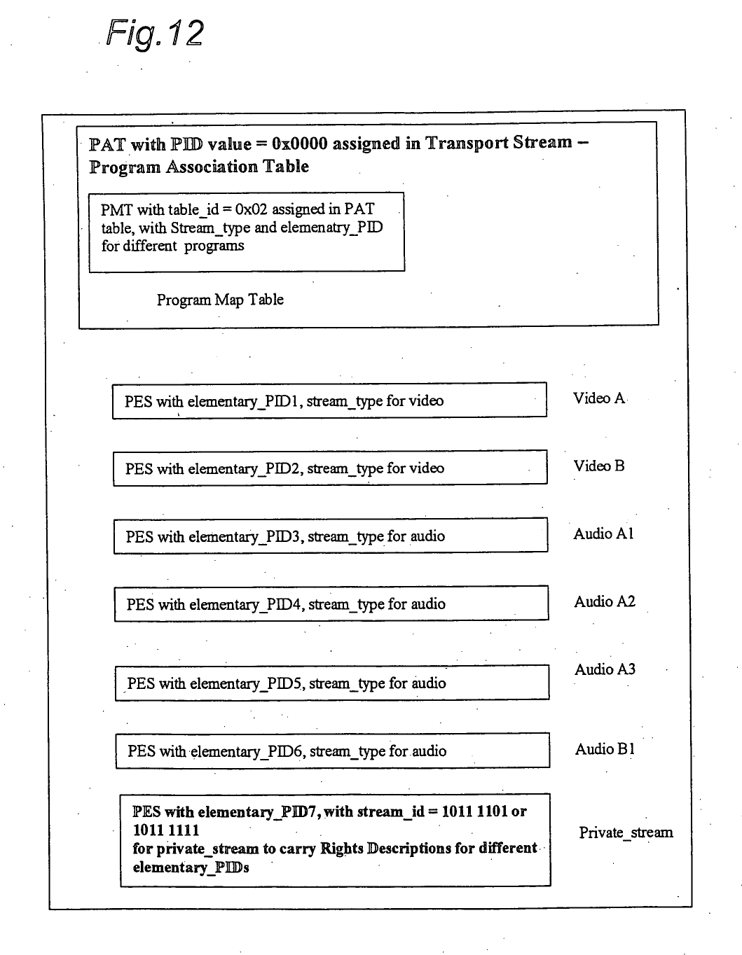

As shown in FIG. 12, alternative place for carrying Rights descriptions in MPEG-2 system is to use one of PESs as a private stream with stream_id=1011 1101 or 1011 1111, as shown in table 3 for selection of stream_id.

TABLE 3
Stream_id Assignments

| stream_id | Note | stream coding |
|---|---|---|
| 1011 1100 | 1 | program_stream_map |
| 1011 1101 | 2 | private_stream_1 |
| 1011 1110 | | padding_stream |
| 1011 1111 | 3 | private_stream_2 |
| 110x xxxx | | ISO/IEC 13818-3 or ISO/IEC |
| | | 11172-3 audio |
| | | stream number x xxxx |
| 1110 xxxx | | ITU-T Rec. H.262 \| ISO/IEC 13818- |
| | | 2 or ISO/IEC 11172-2 video stream |
| | | number xxxx |
| 1111 0000 | 3 | ECM_stream |
| 1111 0001 | 3 | EMM_stream |
| 1111 0010 | 5 | ITU-T Rec. H.222.0 \| ISO/IEC |
| | | 13818-1 Annex A or ISO/IEC |
| | | 13818-6_DSMCC_stream |
| 1111 0011 | 2 | ISO/IEC_13522_stream |
| 1111 0100 | 6 | ITU-T Rec. H.222.1 type A |
| 1111 0101 | 6 | ITU-T Rec. H.222.1 type B |
| 1111 0110 | 6 | ITU-T Rec. H.222.1 type C |
| 1111 0111 | 6 | ITU-T Rec. H.222.1 type D |
| 1111 1000 | 6 | ITU-T Rec. H.222.1 type E |
| 1111 1001 | 7 | ancillary_stream |
| 1111 1010 . . . 1111 1110 | | reserved data stream |
| 1111 1111 | 4 | program_stream_directory |

The notation x means that the value ‘0’ or ‘1’ are both permitted and results in the same stream type. The stream number is given by the values taken by the x's.
Note 1: PES packets of type program_stream_directory have unique syntax specified in 2.5.4.1 on page 63.
Note 2: PES packets of type private_stream_1 and ISO/IEC_13552_stream follow the same PES packet syntax as those for ITU-T Rec. H.222.0 | ISO/IEC 13818-2 video and ISO/IEC 13818-3 audio streams.
Note 3: PES packets of type private_stream_2, ECM_stream and EMM_stream are similar to private_stream_1 except no syntax is specified after PES_packet_length field.
Note 4: PES packets of type program_stream_directory have a unique syntax specified in.2.5.5.1 on page 65.
Note 5: PES packets of type DSM-CC_stream have a unique syntax specified in ISO/IEC 13818-6, which is a compatible extension of ITU-T Rec. H.222.0 | ISO/IEC 13818-1 Annex A.
Note 6: This stream_id is associated with stream_type 0x09 in table 2-36 on page 64.
Note 7. This stream_id is only used in PES packets, which carry data from a Program Stream or an ISO/IEC 11172-1 System Stream, in a Transport Stream.

The third place for carrying Rights Descriptions in MPEG-2 system is to use CA (Conditional Access) section with table_id=0x01 which is assigned in PAT table.

1. A Method of Unified Rights Management for IPMP System, comprising the following steps of:
Using a flexible Rights Description Schema and Language to describe rights and usage rules commonly used in digital content distribution;
Creating a rights envelope with rights and usage rules based on said Rights Description Schema and Language when a digital content is created and encoded; and
Attaching said rights envelope to said content in a specified place to meet the different system specifications, to be distributed to users,
wherein an IPMP terminal has a rights parser based on said rights description schema and language, and
wherein said terminal has rights management function to extract said rights envelope from said content, interpret said rights and usage rules and transfer them to corresponding components in said terminal.

2. A Method of Unified Rights Management for IPMP System, Wherein:
a flexible Rights Description Schema and Language are used to describe rights and usage rules commonly used in digital content distribution;
a rights envelope with rights and usage rules based on said Rights Description Schema and Language is generated when a digital content is created and encoded; and
said rights envelope is attached to said content in a specified place to meet the different system specifications, to be distributed to users, and
wherein said method comprises steps of:
Having an IPMP terminal function with a Rights Parser based on said Rights Description Schema and Language;
Having a Rights Management function to extract said Rights Envelope from said content, interpret said rights and usage rules and transfer them to corresponding components in said terminal;
Receiving said content with said rights descriptions in said rights envelope in said terminal;
Extracting said rights envelope with said rights description from the received content;
Parsing said rights descriptions by said Rights Parser in said terminal, and interpreting each of the rights and usage rules;
Transferring the behaviour message of said rights descriptions to each component in said terminal, to activate said rights and usage rules described by said Rights Descriptions.

3. A Method of Unified Rights Management for IPMP System, wherein:
a flexible Rights Description Schema and Language are used to describe rights and usage rules commonly used in digital content distribution;
an Authoring Tool based on said Rights Description Schema and Language is used for content creation and distribution to place their rights easily, off-line or in real time;
a rights envelope with rights and usage rules is created by using said Authoring Tool when a digital content is created and encoded;
watermark information is embedded in said content using said authoring tool based on said Rights Description Schema and language;
said content is encoded into certain format with or without encryption; and
said rights envelope is attached to said content in a specified place to meet the different system specifications, to be distributed to users, and
wherein said method comprises steps of:
Having an IPMP terminal function with a Rights Parser based on said Rights Description Schema and Language;
Having a Rights Management function to extract said Rights Envelope from said content, interpret said rights and usage rules and transfer them to corresponding components in said terminal;
Receiving said content with said rights descriptions in said envelope in said terminal;
Extracting said rights envelope with the said rights description from the received content;
Parsing said rights descriptions by said Rights Parser in said terminal, and interpreting each of the rights and usage rules;
Transferring the behaviour message of said rights descriptions to each component in said terminal, to activate said rights and usage rules described by said Rights Descriptions.

4. A Method of Unified Rights Management for IPMP System, comprising steps of:
Specifying and defining a flexible Rights Description Schema and Language to describe rights and usage rules commonly used in digital content distribution, including to describe specific identifier for different digital objects in different system, such as OD_ID/ES_ID (ObjectDescriptor ID and Elementary Stream ID) for MPEG-4 system;
Identifying OD_ID and ES_ID with its corresponding rights and usage rules to apply;
Creating a rights envelope with rights and usage rules with the corresponding OD_ID and ES_ID based on said Rights Description Schema and Language when a digital content is created and encoded; and
Attaching said rights envelope to said content in the IOD (Initial Object Descriptor) as one of the initial elementary stream, to be distributed to users,
wherein:
an IPMP terminal has a Rights Parser based on said Rights Description Schema and Language;
said Rights Parser is integrated into said terminal to construct Rights Management with understanding the specified place (IOD) for a content stream to hold said Rights Descriptions;
said terminal has a Rights Management to extract said Rights Envelope from said content, interpret said rights and usage rules and transfer them to corresponding components in said terminal;
said content with said rights descriptions in said rights envelope is received in said terminal;
said content stream which contains Rights Descriptions in IOD is processed by said Rights Management in said Terminal;
said rights descriptions is parsed by said Rights Parser, and interpreting each of said rights and usage rules; and
the behaviour message of said rights descriptions is transferred to each component in said terminal, to activate said rights and usage rules described by said Rights Descriptions.

5. A Method of Unified Rights Management for IPMP System, wherein:
a flexible Rights Description Schema and Language are specified to describe rights and usage rules commonly used in digital content distribution, including to describe specific identifier for different digital objects, such as OD_ID/ES_ID (ObjectDescriptor ID and Elementary Stream ID) for MPEG-4 system;
OD_ID and ES_ID are identified with its corresponding rights and usage rules to apply;
a rights envelope is created with rights and usage rules with the corresponding OD_ID and ES_ID based on said Rights Description Schema and Language when a digital content is created and encoded; and
said rights envelope is carried in an IPMP_ES (IPMP Elementary Stream) which is attached to said OD_ID and ES_ID; and
wherein said method comprises steps of:
Having an IPMP terminal function with a Rights Parser based on said Rights Description Schema and Language;
Integrating said. Rights Parser into said terminal function to construct Rights Management with understanding the specified place (IPMP_ES) for a content stream to hold said Rights Descriptions;
Building said terminal with said Rights Management to extract said Rights Envelope from said content, interpret said rights and usage rules and transfer them to corresponding components in said terminal;
Receiving said content with said rights descriptions in said rights envelope in said terminal;
Processing said content stream which contains Rights Descriptions in said IPMP_ES by said Rights Management in said Terminal;
Parsing said rights descriptions by said Rights Parser, and interpreting each of said rights and usage rules;
Transferring the behaviour message of said rights descriptions to each component in said terminal, to activate said rights and usage rules described by said Rights Descriptions.

6. A Method of Unified Rights Management for IPMP System, comprising the following steps of:
Specifying and defining a flexible Rights Description Schema and Language to describe rights and usage rules commonly used in digital content distribution, including to describe specific identifier for different digital objects, such as Elementary_PID (Elementary Program ID) for MPEG-2 system;
Identifying each Elementary_PID with its corresponding rights and usage rules to apply;
Creating a rights envelope with rights and usage rules with the corresponding Elementary_PID based on said Rights Description Schema and Language when a digital content is created and encoded;
Putting said rights envelope in a Private Section in MPEG-2 system; and
Inserting said Private Section with said rights envelope into TS (Transport Stream), and wherein:
an IPMP terminal is implemented with a Rights Parser based on said Rights Description Schema and Language;
said Rights Parser is integrated into said terminal to construct Rights Management with understanding the specified place (said Private Section) for a content stream to hold said. Rights Descriptions;
said terminal is built with said Rights Management to extract said Rights Envelope from said content, interpret said rights and usage rules and transfer them to corresponding components indicated by elementary_PID in a PMT (Program Map table) in said terminal;
said content with said rights descriptions in said rights envelope is received in said terminal;
said Private Section in said transport stream is processed to retrieve said rights envelope;
said rights descriptions in said rights envelope is parsed by said Rights Parser, and interpreting each of said rights and usage rules; and
the behaviour message of said rights descriptions is transferred to each component indicated by elementary_PID in said terminal, to activate said rights and usage rules described by said Rights Descriptions.

7. A Method of Unified Rights Management for IPMP System, wherein:
a flexible Rights Description Schema and Language is specified to describe rights and usage rules commonly used in digital content distribution, including to describe specific identifier for different digital objects, such as Elementary_PID (Elementary Program ID) for MPEG-2 system;
each Elementary_PID is identified in a PMT table with its corresponding rights and usage rules to apply;
a rights envelope with rights and usage rules is created with the corresponding to their Elementary_PID based on said Rights Description Schema and Language when a digital content is created and encoded; and
said rights envelope is carried in said PES (Program Elementary Stream) stream as a private stream with specified stream_id defined by MPEG-2 system, and
wherein said method comprises steps of:
an IPMP terminal having a Rights Parser based on said Rights Description Schema and Language;
Building said terminal with said Rights Management to extract said Rights Envelope from said content, interpret said rights and usage rules and transfer them to corresponding components indicated by elementary_PID in a PMT (Program Map table) in said terminal;
Integrating said Rights Parser into said terminal to construct Rights Management with understanding the specified place (as a private stream in said PES stream) for a content stream to hold said Rights Descriptions;
Receiving said content with said rights descriptions in said rights envelope in said terminal;
Processing said private stream in said PES with specified stream-id to retrieve said rights envelope;
Parsing said rights descriptions in said rights envelope by said Rights Parser, and interpreting each of said rights and usage rules; and
Transferring the behaviour message of said rights descriptions to each component indicated by Elementary_PID in said terminal, to activate said rights and usage rules described by said Rights Descriptions.

8. A Method of Unified Rights Management for IPMP System, wherein:
a flexible Rights Description Schema and Language is specified to describe rights and usage rules commonly used in digital content distribution, including to describe specific identifier for different digital objects, such as Elementary_PID (Elementary Program ID) for MPEG-2 system;
each Elementary_PID is identified in a PMT table with its corresponding rights and usage rules to apply;
a rights envelope with rights and usage rules is created with the corresponding to their Elementary_PID based on said Rights Description Schema and Language when a digital content is created and encoded; and
said rights envelope is carried in the CA-Section (conditional_access_section) with specified table_id defined by MPEG-2 system, and
wherein said method comprises steps of:
Implementing an IPMP terminal having a Rights Parser based on said Rights Description Schema and Language;
Building said terminal with said Rights Management to extract said Rights Envelope from said content, interpret said rights and usage rules and transfer them to corresponding components indicated by elementary_PID in a PMT (Program Map table) in said terminal;
Integrating said Rights Parser into said terminal to construct Rights Management with understanding the specified place (in CA section) for a content stream to hold said Rights Descriptions;
Receiving said content with said rights descriptions in said rights envelope in said terminal;
Processing said CA_Section with specified table_id to retrieve said rights envelope;
Parsing said rights descriptions in said rights envelope by said Rights Parser, and interpreting each of said rights and usage rules; and
Transferring the behaviour message of said rights descriptions to each component indicated by Elementary_PID in said terminal, to activate said rights and usage rules described by said Rights Descriptions.

9. A Method of Unified Rights Management for IPMP System, comprising steps of:
Specifying a flexible Rights Description Schema and Language to describe rights and usage rules commonly used in digital content distribution, including to describe specific identifier for different digital objects, such as Access_Unit_ID for digital item in MPEG-7 system;
Identifying Access_Unit_ID with its corresponding rights and usage rules to apply;
Creating a rights envelope with rights and usage rules with the corresponding Access_Unit_ID based on said Rights Description Schema and Language when a digital content is created and encoded; and
Attaching said rights envelope to said content in the beginning of said content, to be distributed to users, and wherein:
an MPEG-7 IPMP terminal is implemented with a Rights Parser based on said Rights Description Schema and Language;
said MPEG-7 IPMP terminal is built with said Rights Management to extract said Rights Envelope from said content, interpret said rights and usage rules and transfer them to corresponding components indicated by Access_Unit_ID in said terminal;
said Rights Parser is integrated into said terminal to construct Rights Management with understanding the specified place for a content stream to hold said Rights Descriptions;
said terminal is built to be able to transfer different rights to corresponding components indicated by Access_Unit_ID in said terminal;
said content with said rights descriptions in said rights envelope is received in said terminal;
said content stream which contains Rights Descriptions in said specified place is processed by said Rights Management in said Terminal;
said rights descriptions is parsed by said Rights Parser, and interpreting each of said rights and usage rules; and
the behaviour message of said rights descriptions is transferred to each component indicated by Access_Unit_ID in said terminal, to activate said usage rules described by said Rights Descriptions.

10. A Method of Unified Rights Management for IPMP System, comprising steps of:
Specifying and defining a flexible Rights Description Schema and Language to describe rights and usage rules commonly used in digital content distribution, including to describe specific identifier for different digital objects, such as DID (Digital Item Declaretor) for generic digital item;
Identifying DID with its corresponding rights and usage rules to apply;
Creating a rights envelope with rights and usage rules with the corresponding DID based on said Rights Description Schema and Language when a digital content is created and encoded; and
Attaching said rights envelope to said content in the beginning of said content, to be distributed to users, and wherein:
an IPMP terminal is implemented with a Rights Parser based on said Rights Description Schema and Language;
said terminal is built with said Rights Management to extract said Rights Envelope from said content, interpret said rights and usage rules and transfer them to corresponding components indicated by DID in said terminal;
said Rights Parser is integrated into said terminal to construct Rights Management with understanding the specified place for a content stream to hold said Rights Descriptions;
said terminal is able to transfer different rights to corresponding components indicated by DID in said terminal;
said content with said rights descriptions in said rights envelope is received in said terminal;
said content stream which contains Rights Descriptions in said specified place is processed by said Rights Management in said Terminal;
said rights descriptions is parsed by said Rights Parser, and each of said rights and usage rules are interpreted; and
the behaviour message of said rights descriptions is transferred to each component indicated by DID in said terminal, to activate said usage rules described by said Rights Descriptions.

11. A Method of Unified Rights Management for IPMP System according to claim 1, wherein:
said rights envelope is encrypted by using any existing encryption algorithm; and
said encrypted rights envelope with said rights descriptions is attached to said content.

12. A Method of Unified Rights Management for IPMP System according to claim 1, wherein:
said rights envelope is digitally signed by using any digital signature methods; and
said signed rights envelope with said rights descriptions is attached to said content.

13. A Method of Unified Rights Management for IPMP System according to claim 1, wherein:
said envelope is added with more rights and usage rules automatically in said rights envelope at the point of time when user place request, make payment;
said envelope is converted into binary format; and
said rights envelope in binary format is attached to said content in the specified place;
wherein said envelope is delivered with said content to said IPMP terminal.

14. A Method of Unified Rights Management for IPMP System according to claim 1, wherein:
said Rights Envelope in binary form is converted into XML or XML based format;
a Rights Parser based on said Rights Description Language is built in said terminal; and
said rights descriptions is parsed by said Rights Parser in said terminal, and interpreting each of the rights and usage rules.

15. A Method of Unified Rights Management for IPMP System, wherein a data structure for describing a unified rights and usage rules of a digital content is used, said data structure having a syntax structure for defining said unified rights and usage rules including:
Content description for identifying a digital item of the digital content; and
at least one of play description for defining play rights related to the digital content identified by said content description; and convey description for defining convey rights related to the digital content.

16. A Method of Unified Rights Management for IPMP System according to claim 15, wherein said unified rights and usage rules are described in XML based language.

17. A Method of Unified Rights Management for IPMP System, wherein an IPMP message is attached to a digital content for defining rights and usage rules related to the digital content, said IPMP message comprising:
a unified description of rights and usage rules related to the digital content which is described in accordance with a syntax for defining the rights and usage rules;
said unified description including content description for identifying a digital item of the digital content; and
at least one of play description for defining play rights related to the digital content and convey description for defining convey rights related to the digital content.

18. A Method of Unified Rights Management for IPMP System according to claim 17, wherein said unified description is described in XML or XML based language.

19. A recording medium being recorded with a digital content and an IPMP message, said IPMP message comprising a unified description of rights and usage rules related to the digital content which is described in accordance with a syntax for defining the right and usage rules; and
said unified description including content description for identifying a digital item of the digital content; and
at least one of play description for defining play rights related to the digital content and convey description for defining convey rights related to the digital content.

20. A recording medium according to claim 19 wherein said unified description is described in XML or XML based language.

21. An IMPM system comprising:
a creation section for creating a unified rights and usage rules of a digital content being described in accordance with a syntax for defining the rights and usage rules and includes content description for identifying a digital item of the digital content; and
at least one of play description for defining play rights related to the digital content and convey description for defining convey rights related to the digital content;
an authoring section for placing said unified rights and usage rules for the content to convert them into one file and
a distribution section for transmitting a content stream after multiplexing said one file to the content stream according to a MPEG version installed in an IPMP terminal to which content stream is to be transmitted.

22. An IPMP system according to claim 21, wherein said unified rights and usage rules are described in XML or XML based language.

23. An IPMP system according to claim 21, wherein said one file is formatted in binary format.

24. An IPMP terminal comprising:
a receiving section for receiving a content stream with a unified rights and usage rules of the content, said unified rights and usage rules is described in XML or XML based language and multiplexed to the content stream in accordance with a MPEG version installed in said IPMP terminal;
a rights parser for interpreting each of elements contained in said unified rights and usage rules; and
a rights manager for managing said IPMP terminal in accordance with said unified right and usage rules interpreted by said rights parser.

25. An IPMP terminal according to claim 24, wherein said unified rights and usage rules are formatted in binary format.
